(19) United States
(12) Patent Application Publication
(10) Pub. No.: US 2014/0195476 A1
(43) Pub. Date: Jul. 10, 2014

(54) GENERATING NOTIFICATION FROM DATABASE UPDATE

(71) Applicant: Olaf Sxhmidt, Walldorf (DE)

(72) Inventor: Olaf Sxhmidt, Walldorf (DE)

(73) Assignee: SAP AG, Walldorf (DE)

(21) Appl. No.: 13/738,686

(22) Filed: Jan. 10, 2013

(51) Int. Cl. G06F 17/30

(52) U.S. Cl. CPC G06F 17/30345
USPC 707/609

(57) ABSTRACT

A computer-implemented method for generating a notification from an in-memory database update includes: detecting an in-memory database event that inserts, deletes or modifies a first record in an in-memory database; executing a first database trigger that corresponds to the detected in-memory database event; identifying a first business event definition that is mapped to the executed first database trigger; and generating a first notification that corresponds to the identified first business event definition, the first notification generated for a first subscriber to the identified first business event definition.

### BACKGROUND

Some businesses and other organizations generate relatively large amounts of data in their operations. For example, such data can be transactional data, reflecting many commercial events that relate to the manufacturing process, supply chain and/or sales activities for one or more products. Data can be recorded by the organization or by another entity, and the information can then be used for one or more purposes, such as for reporting.

### SUMMARY

In a first aspect, a computer-implemented method for generating a notification from an in-memory database update includes: detecting an in-memory database event that inserts, deletes or modifies a first record in an in-memory database; executing a first database trigger that corresponds to the detected in-memory database event; identifying a first business event definition that is mapped to the executed first database trigger; and generating a first notification that corresponds to the identified first business event definition, the first notification generated for a first subscriber to the identified first business event definition.

In a second aspect, a computer program product is embodied in a non-transitory computer-readable storage medium and includes instructions that when executed by a processor perform a method for generating a notification from an in-memory database update. The method includes: detecting an in-memory database event that inserts, deletes or modifies a first record in an in-memory database; executing a first database trigger that corresponds to the detected in-memory database event; identifying a first business event definition that is mapped to the executed first database trigger; and generating a first notification that corresponds to the identified first business event definition, the first notification generated for a first subscriber to the identified first business event definition.

In a third aspect, a system includes: one or more processors; and a computer program product embodied in a non-transitory computer-readable storage medium and including instructions that when executed by a processor perform a method for generating a notification from an in-memory database update. The method includes: detecting an in-memory database event that inserts, deletes or modifies a first record in an in-memory database; executing a first database trigger that corresponds to the detected in-memory database event; identifying a first business event definition that is mapped to the executed first database trigger; and generating a first notification that corresponds to the identified first business event definition, the first notification generated for a first subscriber to the identified first business event definition.

Implementations can include any or all of the following features. The first database trigger is executed using a trigger engine operating in a server hosting the in-memory database, the first business event definition is identified by an event publisher operating in an application server associated with the server, and the notification is generated by a notification publisher operating in a gateway system hosted by the application server. An application is operated by executing custom code in an application container hosted by an application server; the first subscriber to the first identified business event includes at least the application; the application generates an alert to a gateway system hosted by the application server, the alert generated using an API of the gateway system; a subscription manager in the gateway system identifies a second subscriber to the generated alert; and a notification publisher hosted by the gateway system generates a second notification that corresponds to the generated alert, the second notification generated for the identified second subscriber. The executed first database trigger further inserts, deletes or modifies a second record in the in-memory database, and the insertion, deletion or modification of the second record further causes a second database trigger to be executed. The first subscriber to the identified business event definition is not a subscriber to a second business event definition that is mapped to the executed second database trigger. The method further includes specifying, before the first database trigger is executed, whether the first database trigger is executed (i) once for each affected record in the in-memory database, or (ii) once for each execution of an operation that affects one or more records in the in-memory database. The method further includes presenting a subscription control adjacent a user interface feature regarding at least the first record in the in-memory database, and activation of the subscription control establishes subscription to the first business event definition.

Implementations can provide any or all of the following advantages. A more flexible and efficient business system can be provided. A business system can allow users to subscribe to business events, corresponding to updates in an in-memory database, and receive real-time information about them. A notification framework can be provided with little or no dependency between database changes and event publishing.

The details of one or more implementations are set forth in the accompanying drawings and the description below. Other features and advantages will be apparent from the description and drawings, and from the claims.

### DESCRIPTION OF DRAWINGS

FIG. 1 shows an example of an architecture.

FIG. 2 shows another example of an architecture.

FIGS. 3 and 4 show examples of methods.

FIGS. 5A-C show example interfaces of one or more applications.

FIG. 6 is a block diagram of a computing system that can be used in connection with computer-implemented methods described in this document.

Like reference symbols in the various drawings indicate like elements.

### DETAILED DESCRIPTION

This document describes systems and techniques for a mobile application to subscribe to get notified when a change of business data is made in an in-memory database. In some implementations, a framework is provided that uses database triggers, which are fired when business data stored in the in-memory database is modified. Such database triggers can be translated into business events by an event provider. The in-memory database can have a gateway component including a push-notification sub-framework, which publishes received business events using a standard OData protocol. OData-based notifications can be delivered to the mobile device(s) by a platform (e.g., a Sybase Unwired Platform). In some implementations, one or more push providers are used for translating notifications (e.g., OData-based) into a corresponding proprietary protocol. As another example, a customer can subscribe to have the notifications stored instead of having them being pushed from the gateway, and the consumer can then pull one or more notifications on-demand.

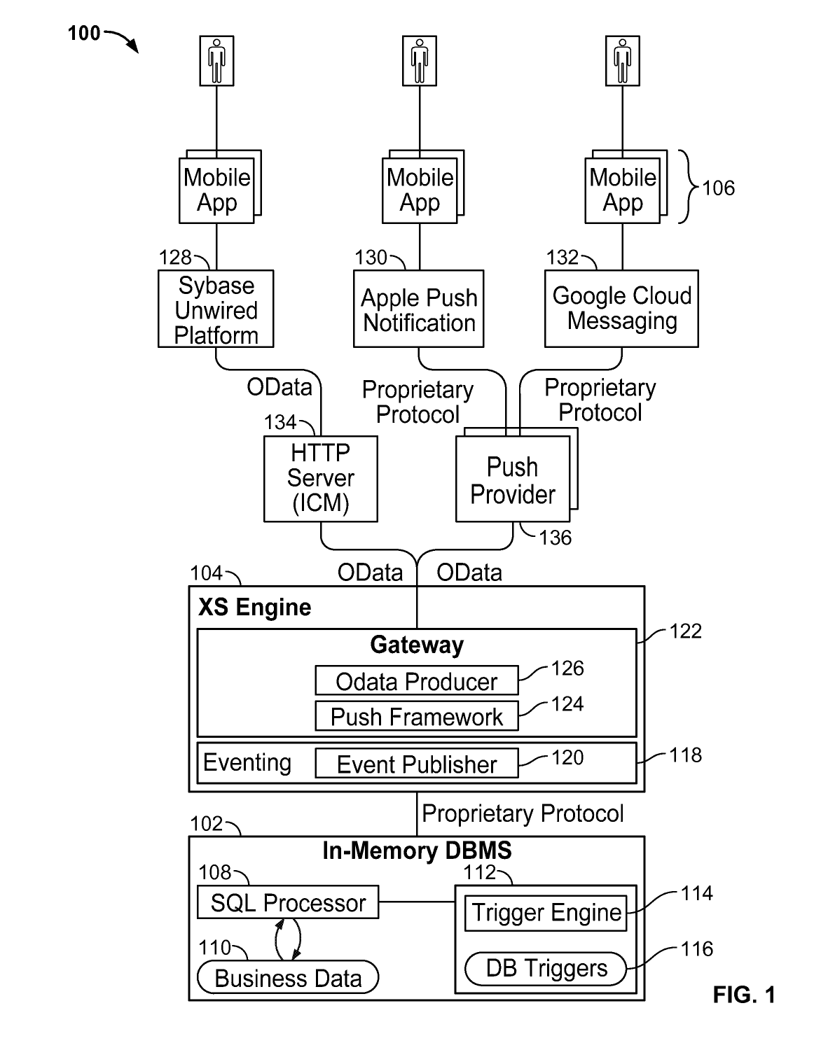

FIG. 1 shows an example of an architecture 100. The architecture 100 includes at least one in-memory database management system (DBMS) 102, at least one extended application service (XS) engine 104, and at least one mobile application 106. In short, the architecture 100 can provide pushing of one or more business-driven notifications, based on at least one database event in the in-memory DBMS 102, to one or more of the mobile applications 106 operated by a user who is a subscriber to the notification.

Implementations of push notifications include, but are not limited to, leave requests by employees, where the notification is sent to mobile devices of one or more managers. For example, these notifications are used in a human capital management (HCM) scenario. Another implementation is that an update of business data in the in-memory database triggers notification when one or more business relevant conditions are met. For example, this can be used to provide real-time reporting. As another example, one or more subscriptions are used to follow changes in a particular sales order document that is stored in, or based on information from, the in-memory database. Another implementation uses a subscription to forward workflow items to one or more users for approval. For example, a user can subscribe to all of a company's customers in California, and the user is then notified as soon as a new California customer is created in the backend system, or when changes are made to any California customer record.

The in-memory DBMS 102 here includes a structured query language (SQL) processor 108 that works with business data 110. The business data 110 can include leave requests, employee records, sales order documents, product records, workflow items, and/or customer records, to name just a few examples. In some implementations, the business data 110 has defined therein one or more views and/or tables.

The in-memory DBMS 102 here includes a trigger component 112 having a trigger engine 114 that works with database triggers 116. One or more of the database triggers 116 can be fired when at least one particular SQL operation is performed on the business data 110, for example on a certain view or table. A database trigger can be used to ensure data consistency (e.g., as an integrity check), and/or to insert, delete or modify reference data. The trigger can be executed before, or after, the referenced table is inserted/deleted/modified. In some implementations, the in-memory DBMS 102 supports an “instead-of” database trigger, for example so that an alternative SQL statement is executed instead of the original insert/delete/modify operation.

In some implementations, one or more of the database triggers 116 can include a definition as to whether the trigger is fired for every modified record or for every execution of a certain operation. In the former case, an update operation performed on 100 records would cause the trigger to be fired 100 times, for example. In the latter case, the trigger would be fired once for the entire update operation, whether the update is done on a single record or multiple records.

In some implementations, at least one of the database triggers 116 can itself insert, delete or modify at least one database record. The database trigger can fire one or more triggers. For example, a hierarchy of event types can be defined that include high level events and low level events. A change of an in-memory database table to insert a sales can result in a corresponding database insert trigger being fired, so the Database insert trigger can be translated into a sales-order created business event. A user can subscribe to one or more of the business events that are notified as a result of the firing of the database trigger. For example, this can allow the user to be notified only about the initial business event, and not about any of those that flow from it.

A relational DBMS (RDBMS) can offer an integrated programming language that can be used for defining triggers, in some implementations PostgreSQL, procedural language/PostgreSQL (PL/pgSQL), PL/SQL (e.g., for Oracle) and/or SQL PL (e.g., for IBM DB2). The RDBMS can support execution of one or more stored procedures during trigger processing. For example, this can allow calling a program written in another programming language (e.g., C, COBOL or Java).

For example, one or more triggers can be used to:
Audit changes (e.g., keep a log of users and roles involved in changes)
Enhance changes (e.g., to ensure that every change to a record is time-stamped by the server's clock)
Enforce business rules (e.g., to require that every invoice has at least one line item)
Execute business rules (e.g., to notify a manager every time an employee's bank account number on file changes)
Replicate data (e.g., to store a record of every change and then provide the record to another database)
Enhance performance (e.g., to update the account balance after each detail transaction, which can make the queries faster to execute

The following pseudocode shows an example of a database trigger definition:

```
  CREATE TRIGGER name FOR {TABLE name | VIEW name}
{BEFORE | AFTER} {INSERT [OR UPDATE] [OR DELETE] | UPDATE
[OR INSERT] [OR DELETE] | DELETE ]OR UPDATE] [OR INSERT] }
    [POSITION n] AS
  BEGIN
    . . .
  END
```

The XS engine 104 can be or include an application server that runs as a database process. For example, the XS engine and the in-memory DBMS can communicate with each other by shared memory.

Here, the XS engine includes an eventing component having an event publisher 120. In some implementations, the eventing component can transfer or translate a database event into one or more business events. For example, the XS engine in the high-performance analytic appliance (HANA) available from SAP AG can be used.

The XS engine 104 includes a gateway system 122 that includes a push framework 124 and an OData producer 126. The gateway system can provide for exposure of services according to one or more protocol (e.g., OData). For example, OData can allow one or more users to define queries and to query data over a network (e.g., the internet). In some implementations, business events can be translated into notifications in OData format and routed to one or more subscribers.

In some implementations, the gateway system 122 supports exposure of services enabled by representational state transfer (REST), such as via a standard OData web protocol for querying and updating data. For example, such an approach can support easy consumption of data stored in the in-memory database, for example by any of various devices and user interface (UI) technologies (e.g., analytical views, calculation views). As another example, runtime data stored in row-/column-store of the in-memory database can be exposed as OData services in the OData producer 126 for easy consumption by lightweight mobile applications.

The push framework 124 enables notifications to be pushed to a mobile device, based on a subscription mechanism. In some implementations, the notification(s) can be pushed in OData protocol format. For example, the OData producer 126 can produce such notifications.

The XS engine 104 can operate with one or more platforms. Some implementations can use a Sybase Unwired Platform (SUP) component 128, an Apple Push Notification (APN) service 130 and/or a Google Cloud Messaging for Android (GCM) service 132. For example, this can help provide a secure and reliable delivery of notification to mobile devices. In short, the mobile devices may not need to register directly with the gateway system 122, but rather that can register with the platforms, such as a messaging service.

The SUP component 128 can consume OData notification, and can work with a hypertext transfer protocol (HTTP) server 134. In some implementations, the HTTP server can be based on an internet communication manager (ICM), such as the ICM available from SAP AG. For example, a user can issue an HTTP request (e.g., using a mobile device) to the server 134, and receive some result in response.

The services 130 and/or 132 can work with one or more push providers 136. In some implementations, the APN service 130 or the GCM component 132 can provide robust and highly efficient services for propagating information to devices including, but not limited to, an iPhone, iPad and/or an Android device. In some implementations, one or more push providers are used to allow third-party application to consume data from an in-memory database system (such as SAP HANA).

For example, a device can establish an accredited and encrypted internet protocol (IP) connection with the service(s) and receive notifications over this persisted connection. If a notification for an application arrives when that application is not running, the device can alert the user that the application has data waiting for it. Different options may exist for deployment of the push provider(s) 136. The push provider(s) can be implemented in a server (e.g., an application server) that is external to the XS engine 104 (e.g., in an Apache Tomcat server), or it can be implemented in the XS engine (e.g., as part of HANA core architecture), to name just two examples. In the latter case, the push provider(s) can run side by side with an ICM, as another example.

In some implementations, a software developer (sometimes referred to as “provider”) can originate the notification(s) in server software. For example, the provider can connect with push notification services through a persistent and secure channel while monitoring incoming data intended for their client applications. When new data for an application arrives, the provider prepares and sends a notification through the channel to the GCN/APN, which pushes the notification to the target device. For example, this can be a lightweight message telling a mobile application that there is new data to be fetched from the server or it could be a message containing limited payload data (e.g., so that apps, such as instant-messaging applications, can directly consume the message). The GCM and/or APN service(s) can handle all aspects of queuing of messages and delivery to the target mobile application running on the target device.

At runtime, the event publisher 120 can push business events or other events by an application programming interface (API) to the gateway system 122 of the XS engine 104. For example, the process to trigger the push of notification is executed by an application running in the XS engine (e.g., in an application container thereof) using a notification-publishing API, or by a native database trigger fired by the trigger engine 114. In some implementations, the trigger concept can be used for maintaining the integrity of the information in the database. For example, when a new record (e.g., for a new employee) is to be added to an employee table, it may be necessary to also create one or more new records in another table, such as a taxation, vacation and/or salary table.

The mobile device(s) can include one or more applications that consume the received (e.g., pushed) notification(s). For example, the application can register the notification and generate a suitable output (e.g., a visible and/or audible alert) to the user. In some implementations, such application can also provide a subscription interface, for example so that the user can register to receive one or more types of notifications.

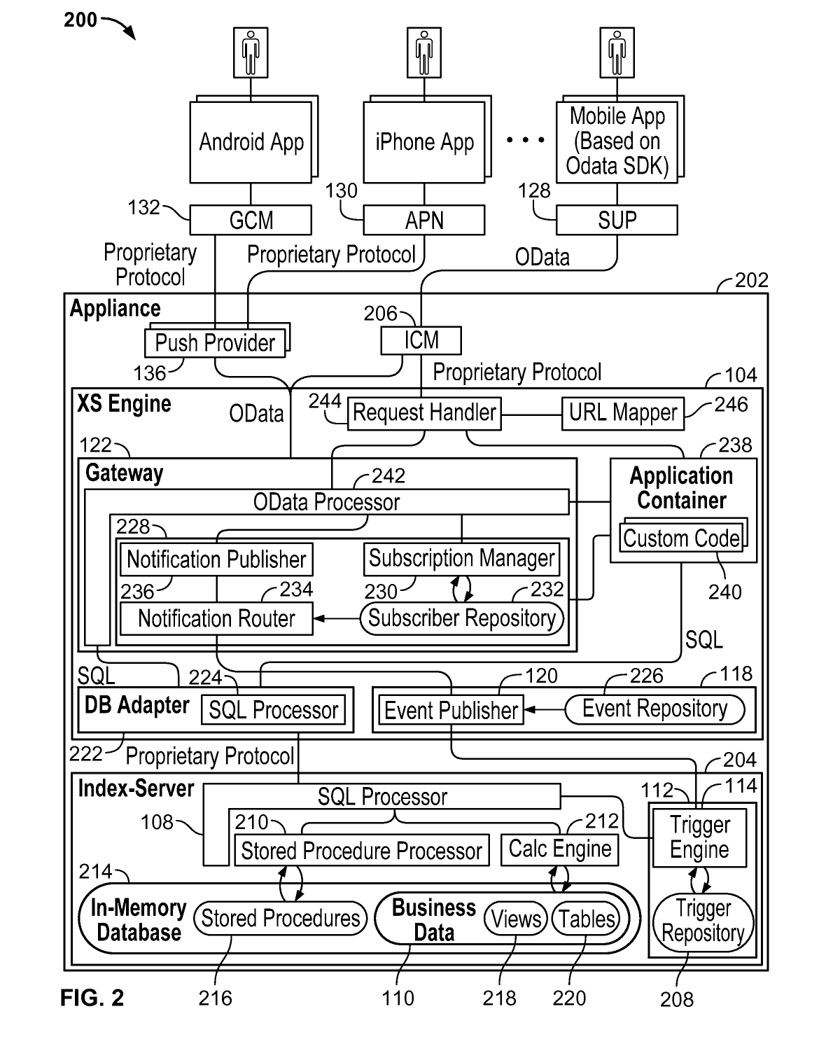

FIG. 2 shows another example of an architecture 200. In some implementations, the architecture 200 includes one or more components similar or identical to one(s) described with reference to the architecture 100 (FIG. 1). Some such examples will be mentioned below.

The architecture 200 can include an appliance 202. In some implementations, this can be or include a flexible, multi-purpose, data-source-agnostic in-memory appliance. This can enable an organization to analyze its business operations using large volumes of detailed information while the business is happening. In some implementations, the organization can instantly explore and analyze all its transactional and analytical data from virtually any data source in real time. For example, operational data can be captured in-memory as the data occurs, and flexible views can expose analytic information for real-time analytics applications. In some implementations, the HANA appliance available from SAP AG can be used.

Here, the appliance 202 includes an index server 204, the XS engine 104, the push provider(s) 136 and an ICM 206. The index server 204 here includes the trigger component 112 that hosts the trigger engine 114 and a trigger repository 208. In some implementations, a database trigger is procedural code that is automatically executed in response to certain events on a particular table or view in an in-memory database. The trigger engine signals a fired database trigger to the event publisher 120. The trigger repository 208 stores database triggers, in some implementations defined via an SQL-command (for example, similar to the pseudocode example described earlier).

In this example, the index server 204 includes the SQL processor 108 which here works with a stored procedure processor 210 and a calculation engine 212. The index server also includes an in-memory database 214 that here includes the business data 110 and stored procedures 216. For example, database triggers can be fired for a row/column store index.

In some implementations, the stored procedure processor 210 can work with the stored procedures 216, and the calculation engine 212 can work with the business data 110. For example, the business data can be organized in terms of views 218 and/or tables 222. The in-memory database 216 can be implemented using SAP HANA in-memory database technology, to name just one example. The XS engine 104 includes a database adapter 222 that here includes an SQL processor 224. For example, the SQL processor 224 can interact with the SQL processor 108 using a proprietary protocol.

Here, the XS engine 104 includes the event component 118, which here includes the event publisher 120 and an event repository 226. In some implementations, the event publisher is responsible for translating database triggers into business events based on the contents of the event repository 226. For example, the event publisher can be signaled by the trigger engine 114 as soon as a database trigger is fired. The event repository 226 can store rules that describe mappings between database triggers and business events. For example, this can allow one or more application to generate subscriptions to the business event(s), rather than having to deal with technical database triggers. The event publisher 120 can be administered using one or more administration UIs. In some implementations, the administration UI can support definition of mapping rules from database triggers to business events. For example, the administration UI can store the newly generated rule(s) in the event repository 226.

Here, the XS engine 104 includes the gateway system 122, which here includes a notification-subscription component 228. In this example, the notification-subscription component includes a subscription manager 230, a subscriber repository 232, a notification router 234, and a notification publisher 236. The subscription manager 230 manages subscriptions to one or more business events. For example, unique identifiers for a user-specific subscription to a certain business event can be persisted, in the subscriber repository 232, in association with a destination (e.g., a notification endpoint). In some implementations, applications running in the XS engine 104 (e.g., in an application container 238) can also subscribe to business events via the notification-publishing API. For example, applications running in the application container of the XS engine can subscribe to business events via the subscription API. The application(s) in the application container 238 can be implemented using custom code 240.

The subscriber repository 232 stores subscription related information. For example, subscription identifiers and/or notification endpoints (i.e., where to push) can be stored.

The notification router 234 listens to the event publisher 120 for business events. When an event occurs the notification router can look up one or more notification endpoints for this particular business event based on the subscriptions stored in the subscriber repository 232.

The notification publisher 236 creates a notification that is to be pushed to one or more mobile devices. The notification(s) can be created based on the information provided by the notification router 234 (e.g., push destination and push data).

The gateway system 122 here includes an OData processor 242 that works with the notification-subscription component 228. For example, the OData processor can ensure that notifications are generated according to the OData protocol.

In some implementations, the push provider(s) 136 can be special implementation(s) for translating OData-based push notification into one or more proprietary protocols of connected push notification platforms, such as the APN service 130 and/or the GCM service 132.

The appliance 202 can include a request handler 244 that communicates with the ICM 206, for example using a proprietary protocol, and interfaces with the gateway system 122 and/or with the application container 238. In some implementations, the request handler uses a uniform resource locator (URL) mapper 246.

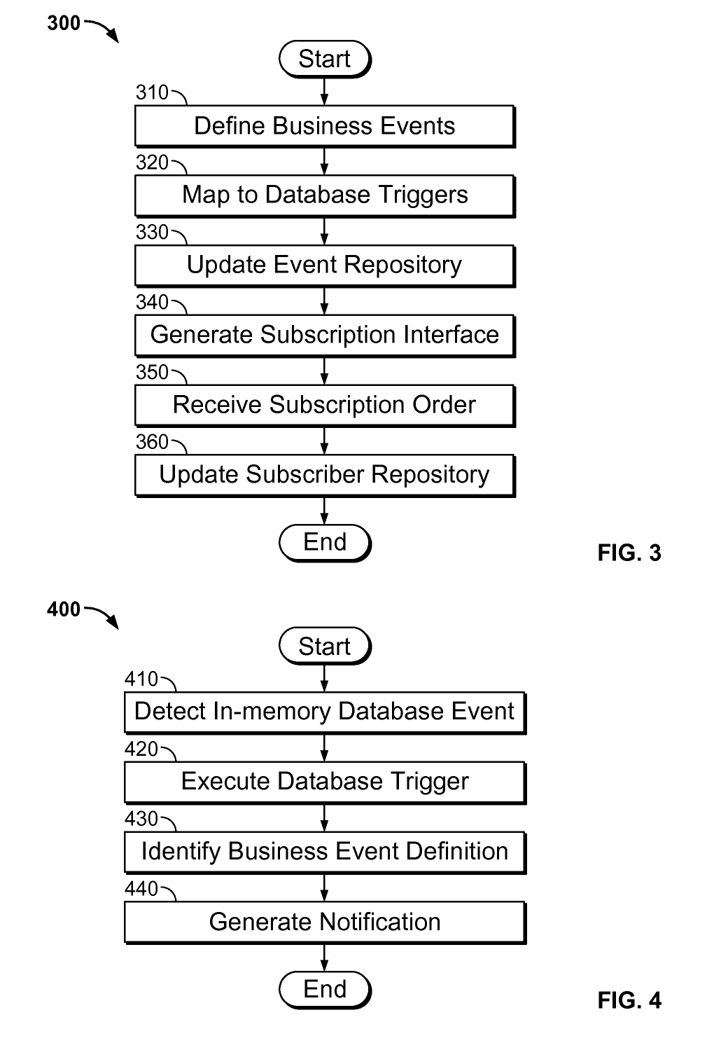

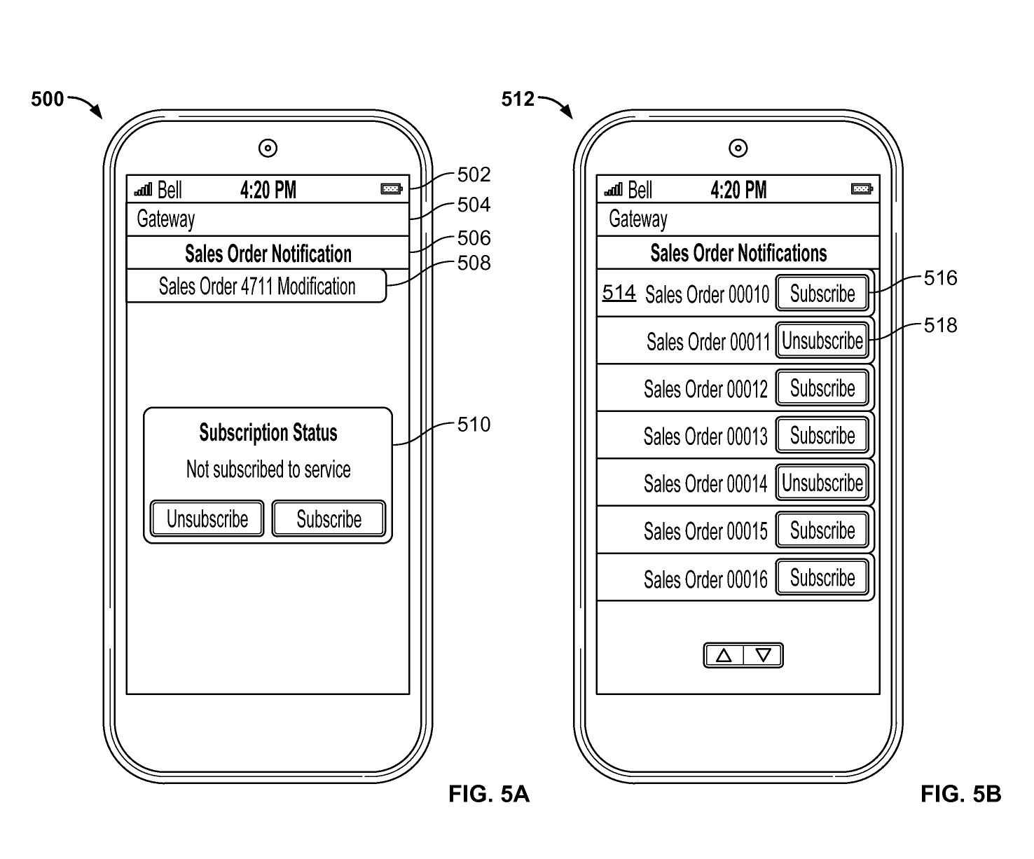

FIGS. 3 and 4 show examples of methods 300 and 400. The methods can be performed by one or more processors executing instructions stored in a computer-readable medium. For example, the method(s) can be performed in the architecture 100 (FIG. 1) and/or in the architecture 200 (FIG. 2).

The method 300 relates to defining the push framework and setting up one or more subscriptions. At 310, one or more business events are defined. In some implementations, the database trigger(s) can also be defined.

At 320 the business event(s) can be mapped to the database trigger(s). For example, business event(s) can be specified for a certain database trigger (e.g., the trigger can be modified for a particular view).

At 330, an event repository is updated. For example, one or more rules describing mappings between database triggers and business events can be stored.

At 340, a subscription interface is generated.

At 350, one or more subscription orders from a user can be received. For example, a REST-enabled device or service can subscribe to a certain business event.

At 360, a subscriber repository can be updated. For example, one or more unique identifiers for a user-specific subscription to a certain business event, and a notification endpoint, can be persisted.

The method 400 relates to sending one or more notifications to subscriber(s) based on a business event. At 410, one or more in-memory database events are detected. For example, it can be detected that a database view or table is updates.

At 420, a database trigger is executed. With reference again to FIG. 2, based on the trigger repository 208, the trigger engine 114 can execute a database trigger that corresponds to an update of the in-memory database 214. The trigger engine can then call the event publisher 120.

At 430, at least one business event definition is identified based on the executed database trigger. For example, a mapping in an event repository can be used to identify (e.g., by an event publisher) the corresponding business event definition(s). An event publisher can then fire a corresponding business event, which can be received and/or detected by the notification router 234.

At 440, the notification(s) can be generated to the appropriate subscriber(s). For example, the subscriber(s) can be identified (e.g., by a notification router) as one or more notification endpoints, and then be published by a notification publisher. As another example, an application (e.g., in an application container) can also or instead subscribe to events. In such situations, the application can react accordingly (e.g., by recalculating certain data), and/or by sending a notification.

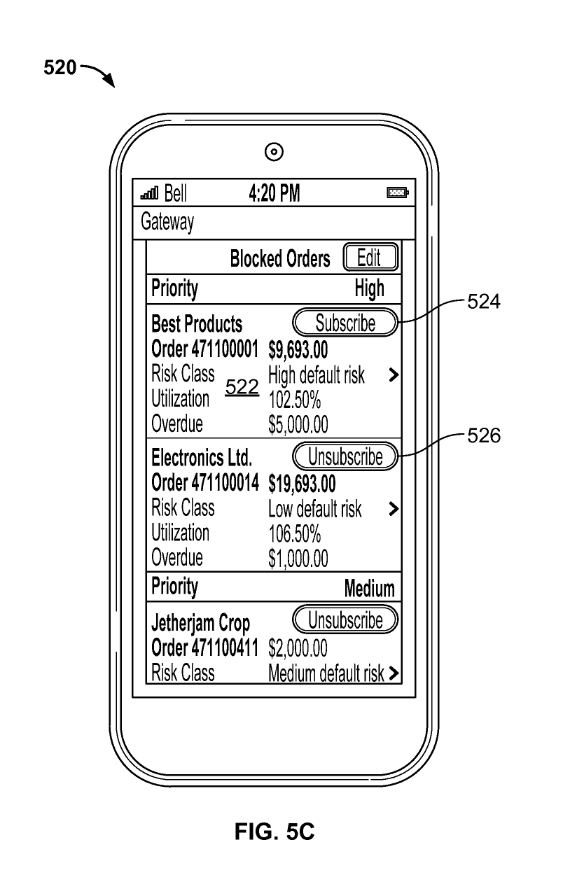

FIGS. 5A-C show example interfaces of one or more applications. FIG. 5A shows an example of an interface 500 that can be generated by an application that works with an in-memory database. For example, an application using the in-memory DBMS 102 (FIG. 1), and/or an application using the in-memory database 214 (FIG. 2) can use the interface 500. The interface 500 illustrates an example of an initial set-up process for receiving notification for a particular sales order, here called “4711”. That is, the user can subscribe to a particular sales order, or to several sales orders (or even notifications for various business events).

In this implementation, the interface 500 indicates that the application relates to sales orders. The application may be designed for use in creating sales orders (e.g., when a customer places an order), managing sales orders (e.g., when the sales order is being fulfilled), and/or in documenting sales (e.g., by generating a record of the sales transaction), to name just a few examples.

Here, the interface 500 is generated on a mobile device. In some implementations, this can include, but is not limited to, one or more of the mobile devices described with reference to FIGS. 1-2. For example, the mobile device can be operated by a manager in a company's sales department who subscribes to the business events that reflect modification (or creation, deletion, etc.) of a sales order.

The interface 500 includes an area 502 that can present one or more types of information. This can include, but is not limited to, network information (e.g., a wireless service provider), geographic or other local information (e.g., a current time), and/or device-specific information (e.g., status of a rechargeable battery).

The interface 500 includes an area 504 that can present system-related information. In this implementation, the application is interfacing with a gateway system, and this is indicated in the area 504. With reference again to FIG. 2, the gateway system 122 can be implemented in the SAP HANA XS engine, and the gateway can be used for providing push service from that system.

The interface 500 includes a notification heading 506. The interface can present a list of incoming notifications for subscribed events (e.g., a mailbox-type display), and the user can select one or more notifications from the list to receive details.

For example, the current user may be a subscriber to business events relating to sales orders, and after an update of an in-memory database regarding one or more sales orders, the corresponding trigger(s) can be fired and the mapped notification(s) can be pushed to their respective subscribers. In this implementation, the notification heading 506 indicates that that this mobile device has received a notification regarding a sales order.

The interface includes push content area 508 that presents one or more pieces of information that are being pushed to the subscriber. Here, the notification relates to a modification of “Sales Order 4711”. In this implementation, the push content area 508 is interactive so that the user can obtain further information about the business event if he or she is interested. For example, the user can click on (or otherwise activate) the push content area and this can present additional information about the notified modification, such as what the modification is, when and by whom it was made.

A subscription status area 510 currently indicates that the user is not registered as a subscriber to the notification service for this sales order. Accordingly, the user can activate a “Subscribe” control to sign up for subscription. In contrast, had the user currently been a subscriber, the area 510 would have indicated this fact, and the user would have had the option of activating an “Unsubscribe” control instead.

FIG. 5B shows another example of an interface 512 that can present one or more sales order items 514. For example, the user performs a query (e.g., using a search function on the in-memory database), and the resulting sales order item(s) are presented in the interface 512. Here, the sales order item 514 corresponds to a sales order named “00010”. If the user clicks on (or otherwise activates) the sales order item, the user can access additional information including, but not limited to, the sales order itself and related data.

The interface 512 presents a subscription control 516 in association with the sales order item 514. For example, the control 516 can be presented on, next to or in the vicinity of the sales order item with which it is associated. The control 516 currently says “Subscribe,” which indicates that the user is not currently registered as a subscriber for the sales order “00010”. Rather, by clicking on (or otherwise activating) the control 516 the user can sign up for such a subscription. By contrast, another subscription control 518 indicates that the user is currently subscribing to notifications about another sales order called “00011,” and the control 518 therefore provides a way for the user to unsubscribe from that sales order, if he or she wishes.

FIG. 5B shows another example of an interface 520 that can present one or more blocked sales order items 522. For example, each item corresponds to a sales order that has been blocked (e.g., a sales order named “471100001” for the item 522), and can list some information about it, such as a risk classification, a utilization, and/or an overdue amount. The interface 520 presents a subscription control 524 in association with the sales order item 522. For example, the control 524 can be presented on, next to or in the vicinity of the blocked sales order item with which it is associated. The control 524 currently says “Subscribe,” which indicates that the user is not currently registered as a subscriber for the sales order “471100001”. Rather, by clicking on (or otherwise activating) the control 524 the user can sign up for such a subscription. By contrast, another subscription control 526 indicates that the user is currently subscribing to notifications about another sales order called “471100014,” and the control 526 therefore provides a way for the user to unsubscribe from that sales order.

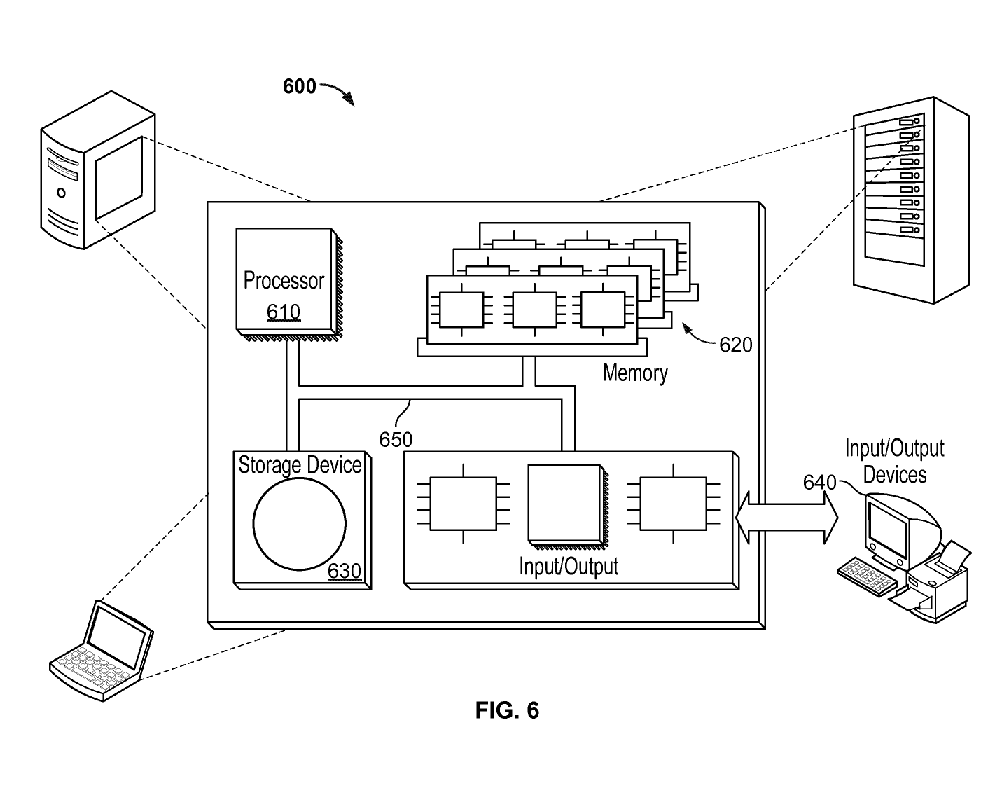

FIG. 6 is a schematic diagram of a generic computer system 600. The system 600 can be used for the operations described in association with any of the computer-implement methods described previously, according to one implementation. The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. The memory 620 is a volatile memory unit in some implementations and is a non-volatile memory unit in other implementations.

The storage device 630 is capable of providing mass storage for the system 600. In one implementation, the storage device 630 is a computer-readable medium. In various different implementations, the storage device 630 may be a floppy disk device, a hard disk device, an optical disk device, or a tape device.

The input/output device 640 provides input/output operations for the system 600. In one implementation, the input/output device 640 includes a keyboard and/or pointing device. In another implementation, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations have been described. Nevertheless, it will be understood that various modifications may be made without departing from the spirit and scope of this disclosure. Accordingly, other implementations are within the scope of the following claims.

What is claimed is:

1. A computer-implemented method for generating a notification from an in-memory database update, the method comprising:
detecting an in-memory database event that inserts, deletes or modifies a first record in an in-memory database;
executing a first database trigger that corresponds to the detected in-memory database event;
identifying a first business event definition that is mapped to the executed first database trigger; and
generating a first notification that corresponds to the identified first business event definition, the first notification generated for a first subscriber to the identified first business event definition.

2. The computer-implemented method of claim 1, wherein the first database trigger is executed using a trigger engine operating in a server hosting the in-memory database, wherein the first business event definition is identified by an event publisher operating in an application server associated with the server, and wherein the notification is generated by a notification publisher operating in a gateway system hosted by the application server.

3. The computer-implemented method of claim 1, wherein:
an application is operated by executing custom code in an application container hosted by an application server;
the first subscriber to the first identified business event includes at least the application;
the application generates an alert to a gateway system hosted by the application server, the alert generated using an API of the gateway system;
a subscription manager in the gateway system identifies a second subscriber to the generated alert; and
a notification publisher hosted by the gateway system generates a second notification that corresponds to the generated alert, the second notification generated for the identified second subscriber.

4. The computer-implemented method of claim 1, wherein the executed first database trigger further inserts, deletes or modifies a second record in the in-memory database, and wherein the insertion, deletion or modification of the second record further causes a second database trigger to be executed.

5. The computer-implemented method of claim 4, wherein the first subscriber to the identified business event definition is not a subscriber to a second business event definition that is mapped to the executed second database trigger.

6. The computer-implemented method of claim 1, further comprising specifying, before the first database trigger is executed, whether the first database trigger is executed (i) once for each affected record in the in-memory database, or (ii) once for each execution of an operation that affects one or more records in the in-memory database.

7. The computer-implemented method of claim 1, further comprising presenting a subscription control adjacent a user interface feature regarding at least the first record in the in-memory database, wherein activation of the subscription control establishes subscription to the first business event definition.

8. A computer program product embodied in a non-transitory computer-readable storage medium and comprising instructions that when executed by a processor perform a method for generating a notification from an in-memory database update, the method comprising:
detecting an in-memory database event that inserts, deletes or modifies a first record in an in-memory database;
executing a first database trigger that corresponds to the detected in-memory database event;
identifying a first business event definition that is mapped to the executed first database trigger; and
generating a first notification that corresponds to the identified first business event definition, the first notification generated for a first subscriber to the identified first business event definition.

9. The computer program product of claim 8, wherein the first database trigger is executed using a trigger engine operating in a server hosting the in-memory database, wherein the first business event definition is identified by an event publisher operating in an application server associated with the server, and wherein the notification is generated by a notification publisher operating in a gateway system hosted by the application server.

10. The computer program product of claim 8, wherein:
an application is operated by executing custom code in an application container hosted by an application server;
the first subscriber to the first identified business event includes at least the application;
the application generates an alert to a gateway system hosted by the application server, the alert generated using an API of the gateway system;
a subscription manager in the gateway system identifies a second subscriber to the generated alert; and
a notification publisher hosted by the gateway system generates a second notification that corresponds to the generated alert, the second notification generated for the identified second subscriber.

11. The computer program product of claim 8, wherein the executed first database trigger further inserts, deletes or modifies a second record in the in-memory database, and wherein the insertion, deletion or modification of the second record further causes a second database trigger to be executed.

12. The computer program product of claim 11, wherein the first subscriber to the identified business event definition is not a subscriber to a second business event definition that is mapped to the executed second database trigger.

13. The computer program product of claim 8, the method further comprising specifying, before the first database trigger is executed, whether the first database trigger is executed (i) once for each affected record in the in-memory database, or (ii) once for each execution of an operation that affects one or more records in the in-memory database.

14. The computer program product of claim 8, the method further comprising presenting a subscription control adjacent a user interface feature regarding at least the first record in the in-memory database, wherein activation of the subscription control establishes subscription to the first business event definition.

15. A system comprising:
one or more processors; and
a computer program product embodied in a non-transitory computer-readable storage medium and comprising instructions that when executed by a processor perform a method for generating a notification from an in-memory database update, the method comprising:
detecting an in-memory database event that inserts, deletes or modifies a first record in an in-memory database;
executing a first database trigger that corresponds to the detected in-memory database event;
identifying a first business event definition that is mapped to the executed first database trigger; and
generating a first notification that corresponds to the identified first business event definition, the first notification generated for a first subscriber to the identified first business event definition.

16. The system of claim 15, wherein the first database trigger is executed using a trigger engine operating in a server hosting the in-memory database, wherein the first business event definition is identified by an event publisher operating in an application server associated with the server, and wherein the notification is generated by a notification publisher operating in a gateway system hosted by the application server.

17. The system of claim 15, wherein:
an application is operated by executing custom code in an application container hosted by an application server;
the first subscriber to the first identified business event includes at least the application;
the application generates an alert to a gateway system hosted by the application server, the alert generated using an API of the gateway system;
a subscription manager in the gateway system identifies a second subscriber to the generated alert; and
a notification publisher hosted by the gateway system generates a second notification that corresponds to the generated alert, the second notification generated for the identified second subscriber.

18. The system of claim 15, wherein the executed first database trigger further inserts, deletes or modifies a second record in the in-memory database, and wherein the insertion, deletion or modification of the second record further causes a second database trigger to be executed.

19. The system of claim 18, wherein the first subscriber to the identified business event definition is not a subscriber to a second business event definition that is mapped to the executed second database trigger.

20. The system of claim 15, the method further comprising presenting a subscription control adjacent a user interface feature regarding at least the first record in the in-memory database, wherein activation of the subscription control establishes subscription to the first business event definition.
